(19) United States
(12) Patent Application Publication
(10) Pub. No.: US 2025/0244478 A1
(43) Pub. Date: Jul. 31, 2025

(54) SYSTEMS AND METHODS FOR PROCESSING DIGITAL HIGH DEFINITION MAPS

(71) Applicant: Woven by Toyota, Inc., Tokyo (JP)

(72) Inventors: Edward Higgins, Redmond, WA (US); Matthew R. Sayler, Tacoma, WA (US); Jaspal Singh, Hicksville, NY (US)

(73) Assignee: Woven by Toyota, Inc., Tokyo (JP)

(21) Appl. No.: 18/422,654

(22) Filed: Jan. 25, 2024

(51) Int. Cl. G01S 17/89; G01S 7/51

(52) U.S. Cl. CPC G01S 17/89; G01S 7/51

(57) ABSTRACT

In one embodiment, a method for processing a high definition map includes scanning an environment with a lidar scanner to generate lidar data, generating the high definition map from the lidar data, where the high definition map further includes a plurality of features defined by vector data derived from the lidar data, applying a plurality of buckets to the high definition map, where each bucket of the plurality of buckets includes a plurality of lidar points of the lidar data, for each bucket of the plurality of buckets, determining an attribute from the plurality of lidar points, and adjusting one or more features of the plurality of features based at least in part on the attributes of the plurality of buckets.

### BACKGROUND

A high-definition map is a map that includes data captured from one or more sources, such as lidar scanners. Lidar scanners produce lidar data in the form of lidar points that represent objects within the environment. More particularly, lidar scanners emit light (e.g., infrared light) into an environment and has one or more detectors that receive and detect light emitted by the scanner that has been reflected by objects within the environment. The distance of an object from the lidar scanner, and thus the location of an object within the environment, is determined by the amount of time it takes for the reflected light to be received by the one or more detectors.

The resulting lidar data of the environment is in the form of a plurality of lidar points, often referred to as a point cloud. Features within the lidar data, such as objects like cars, signs and the like, may be derived from the lidar data. These features can be represented by vectors within the high-definition map. For example, lane lines of a road may be represented by digital vectors within a vector layer of the high-definition map.

In some instances, there may be a misalignment between the features represented by vectors within the vector layer and the lidar points of the lidar data. For example, the lane lines represented by vectors should be positioned on a planar surface of the road represented by the lidar data. These lane lines may be erroneously positioned above or below the planar surface of the road. Thus, the vector data of the lane lines should be adjusted such that the lane lines rest on top of the road surface as defined by the lidar data. Due to the voluminous amount of data of a high-definition map, particularly the millions of lidar points of the lidar data, it can be difficult and computationally expensive to find discrepancies between vector data and lidar data.

Additionally, it may be desired to find discrepancies between two temporally separated lidar scans generated by one or more lidar scanners. For example, a second lidar scan of an environment may occur days, months or years after a first lidar scan of the same environment. It may be desired to understand the differences between the lidar data of the second lidar scan from the lidar data of the first lidar scan, for example. However, the task of determining the differences is difficult and computationally expensive due to the large of amount of lidar data between the two lidar scans.

Accordingly, alternative systems and methods for processing a high definition map, and particularly identifying differences and discrepancies within the high definition maps, may be desired.

### BRIEF SUMMARY

In one embodiment, a method for processing a high definition map includes scanning an environment with a lidar scanner to generate lidar data, generating the high definition map from the lidar data, where the high definition map further includes a plurality of features defined by vector data derived from the lidar data, applying a plurality of buckets to the high definition map, where each bucket of the plurality of buckets includes a plurality of lidar points of the lidar data, for each bucket of the plurality of buckets, determining an attribute from the plurality of lidar points, and adjusting one or more features of the plurality of features based at least in part on the attributes of the plurality of buckets.

In another embodiment, a system for processing a high definition map includes one or more processors. The system also includes a non-transitory computer-readable medium storing instructions that, when executed by the one or more processors, cause the one or more processors to receive lidar data of an environment, generate the high definition map from the lidar data, where the high definition map further includes a plurality of features defined by vector data derived from the lidar data, apply a plurality of buckets to the high definition map, where each bucket of the plurality of buckets includes a plurality of lidar points of the lidar data, for each bucket of the plurality of buckets, determine an attribute from the plurality of lidar points, and adjusting one or more features of the plurality of features based at least in part on the attributes of the plurality of buckets.

In another embodiment, a system for processing a high definition map includes one or more processors. The system also includes a non-transitory computer-readable medium storing instructions that, when executed by the one or more processors, cause the one or more processors to receive first lidar data of an environment, receive second lidar data from the environment, generate a first high definition map from the first lidar data and a second high definition map from the second lidar data, where each of the first high definition map and the second high definition map includes a plurality of features defined by vector data derived from the lidar data, apply a first plurality of buckets to the first high definition map and a second plurality of buckets to the second high definition map, where each bucket of the first plurality of buckets and the second plurality of buckets includes a plurality of lidar points of one of the first lidar data and the second lidar data, for each bucket of the first plurality of buckets and the second plurality of buckets, determine an attribute from one of the first plurality of lidar points and the second plurality of lidar points, and compare the attribute of each bucket of the first plurality of buckets to the attribute of each spatially corresponding bucket of the second plurality of buckets. The system also includes display the second high definition map and the second plurality of buckets on an electronic display, where each bucket of the second plurality of buckets visually indicates a difference between the attribute of an individual bucket and the spatially corresponding bucket of the first plurality of buckets.

### BRIEF DESCRIPTION OF THE SEVERAL VIEWS OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates an example environment for embodiments described and illustrated herein.

FIG. 2 illustrates an example high definition map according to one or more embodiments described and illustrated herein.

FIG. 3 illustrates a flow chart of an example method for processing a high definition map according to one or more embodiments described and illustrated herein.

FIG. 4 illustrates an example high definition map with a plurality of buckets according to one or more embodiments described and illustrated herein.

FIG. 5 illustrates a flow chart of an example method for processing a high definition map according to one or more embodiments described and illustrated herein.

FIG. 6 illustrates an example computing device for processing a high definition map according to one or more embodiments described and illustrated herein.

### DETAILED DESCRIPTION

Embodiments of the present disclosure are directed to systems and methods for processing high definition map data and, more particularly, to systems and methods for detecting discrepancies between lidar data and vector data of a high definition map, as well as differences between the lidar data of two different high definition maps. Embodiments significantly reduce the amount of data required to detect these discrepancies and differences (and therefore reduce the processing power to do so) by the use of polygonal buckets encompassing lidar points arranged on a high definition map according to a uniform grid that is overlaid on the high definition map. One or more attributes are derived from the lidar points within each bucket.

In one example, the attributes of the buckets are then compared with attributes of vector data associated with features within a vector layer of the high definition map to determine if there are discrepancies between the lidar data and the vector data of the high definition map. The use of buckets and their attributes significantly reduces the amount of data needed to compare the lidar data with the vector data to find discrepancies. With the methods of the present disclosure, only the attribute data of the buckets may be compared to the vector data rather than the lidar data itself.

In another example, the differences between the lidar data of two different lidar scans is determined by calculating attributes of lidar points within individual buckets of the high definition dataset, and then comparing the attributes between the two high definition maps to determine differences. Comparing the attributes of the buckets between the two high definition maps rather than comparing individual lidar points significantly reduces the time and processing power for determining the differences between maps.

Various embodiments of systems and methods for processing high definition maps are described in detail below.

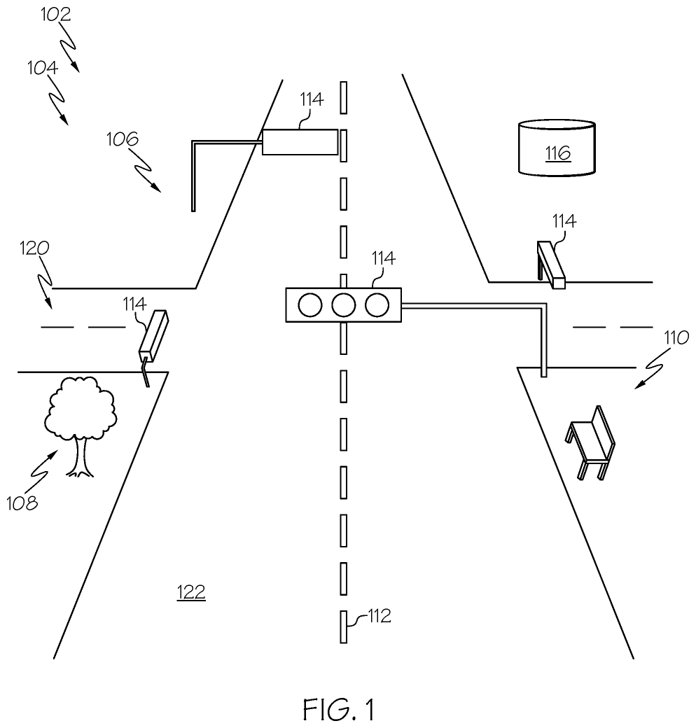

Referring now to FIG. 1, an example environment 102 is illustrated. The environment 102 is an intersection 106 of a road 120 and a road 122. Within the environment 102 are various features, such as lane lines 112, traffic lights 114, a planter 108, and a bench 110. It should be understood that any features may present within the environment 102. To obtain a high definition map 104 of the environment 102, a lidar scanner 116 is moved through the environment 102 to produce lidar data in the form of a plurality of lidar points (i.e., a point cloud). The plurality of lidar points represents features within the environment 102 such as a high definition map 104, traffic lights 114, benches 110, curbs, signs and other objects. Each feature is represented by a sub-set of the plurality of lidar points. For example, the planter 108 as a sub-set of the plurality of lidar points associated therewith.

After the lidar scanner obtains the lidar data, the lidar data is used to create a high definition map 104 of the environment 102. In addition to the lidar data, additional features may be digitally inserted into the high definition map 104. For example, vector features may be included in a vector layer that provide additional information for the high definition map 104. The vector map features may be represented by polygonal, linear, or point geometries. As a non-limiting example, a vector feature may be lane lines 112 that are provided in the vector layer that correspond with the surface of the roads 120, 122 as defined by the lidar data.

Using the lane line 112 example, the vector features representing a lane line 112 within the vector layer should be in the same plane as the surface of a road 122 as defined by the lidar data. In other words, the vector features representing a lane line should not be offset from the surface of the road 122 in the z-axis (i.e., elevation). Depending on the type of object represented by the vector features, other criterion should be met, such as lateral offset.

Because of the extremely large number of lidar data points within the high definition map, it may take a significant amount of time and computing power to determine if the vector features and the lidar data are in agreement. That is, it is determined if the vector features are properly positioned within the map according to the lidar data.

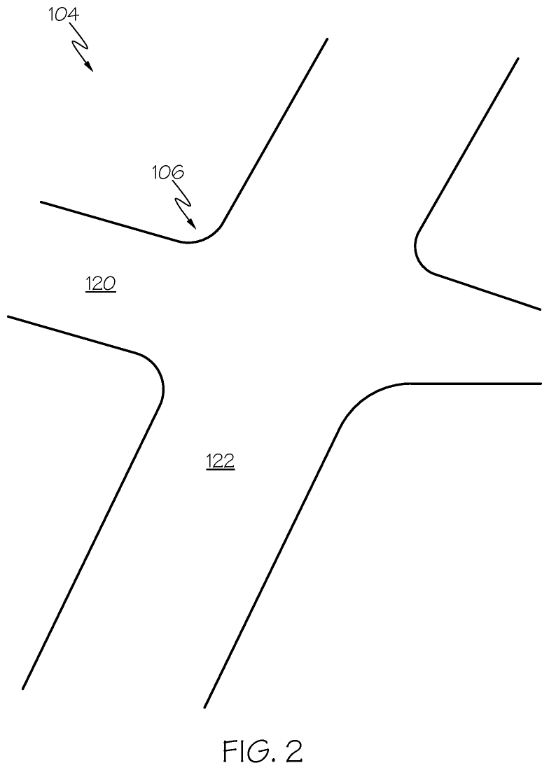

FIG. 2 is a simplified illustration of a high definition map 104. Although only lane lines 112 are shown within the 120, 122, it should be understood that many other vector features representing objects within the environment may be included in the high definition map 104. Further, it should be understood that the high definition map 104 may represent a geographical region of any size, such as a neighborhood, a town or city, a county, and/or the like.

Embodiments of the present disclosure minimize the processing time and power to analyze the high definition map 104 for potential discrepancies by reducing the amount of lidar data used to perform such tasks. Generally, embodiments generate a plurality of buckets, calculate one or more attributes for each bucket, and then use the attributes to perform desired operations rather than the lidar data itself. The buckets are durable, persistent entities such that they are consistent in position in spite of the composition of the lidar datasets being variable. The buckets may be performed manually by human operators, or they may be automatically generated, such as by artificial intelligence-based vector generation techniques.

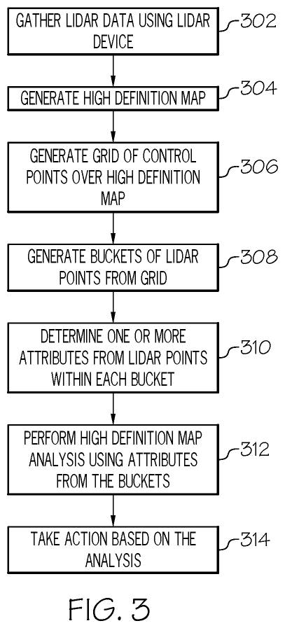

Referring now to FIG. 3, a flowchart of an example method of processing a digital high definition map comprising lidar data is illustrated. At block 302 the lidar data is gathered by using a lidar device such as, without limitation, a lidar scanner 116 as described above. At block 316, a high definition map 104 including the lidar data from the lidar device is generated. The high definition map may also include a vector layer including a plurality of vector features defining objects within the environment that the high definition map 104 represents. The vector layer may be spatially aligned with the lidar data such that the vector features are in the proper three-dimensional spaces of the high definition map with respect to the lidar data.

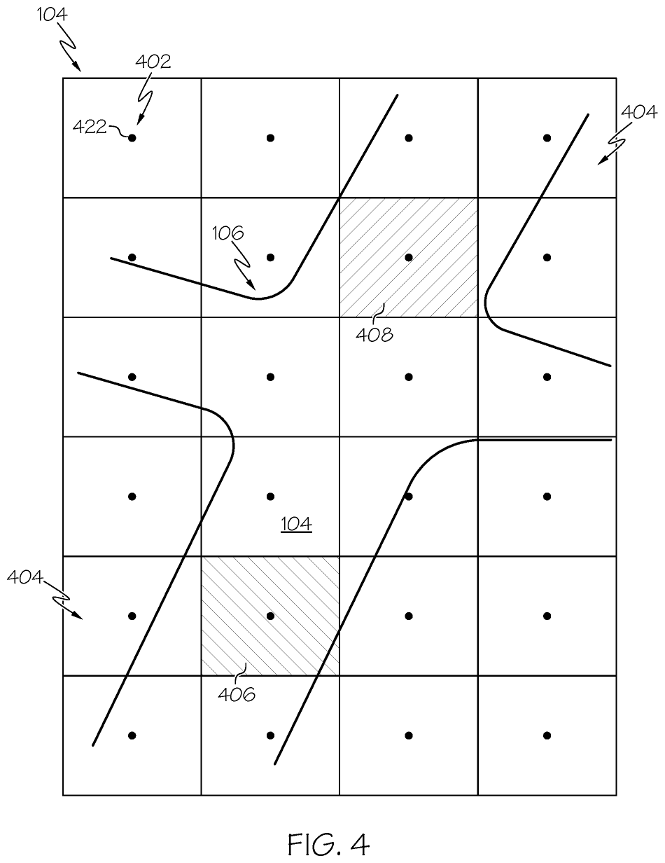

At block 306 a uniform grid 402 of control points 422 is overlaid on at least a portion of the high definition map 104. FIG. 4 illustrates the high definition map 104 of FIG. 3 with a uniform grid 402 overlaid thereon. The grid 402 should be uniform at a desired resolution. Embodiments are not limited by any resolution. As non-limiting examples, the control points 422 of the uniform grid 402 may have a resolution of 1 meter, 3 meters, 5 meters, 10 meters, or 20 meters. The resolution chosen may depend on the density of objects within the high definition map 104 and/or the geographical size of the high definition map 104.

A polygonal bucket 404 is generated at one or more of the control points 422 of the uniform grid 402 at block 308 to generate a plurality of buckets 404 encompassing at least a portion of the high definition map 104. Each polygonal bucket 404 is generated to encompass the lidar points surrounding an individual control point. Although FIG. 4 shows each bucket 404 as being rectangular in shape, embodiments are not limited thereto. The buckets 404 may have any shape depending on the objects represented by the lidar data. Additionally, the plurality of buckets 404 may not have a uniform shape in that each bucket 404 may have a unique shape.

The buckets 404 may be derived from defining three-dimensional point geometry that functions as a centroid (anchor point) for a polygonal shape that is programmatically derived based on desired polygonal shape (square, rectangle, triangle, circle, oval, hexagon, octagon or some irregular morphology that can be programmatically generated). The three-dimensional point geometries can be defined as a regularly spaced grid to mimic a continuous raster mesh of adjacent buckets or defined as single buckets for specific, targeted areas of a map (i.e., a known trouble spot or specific focus area). As stated above, the buckets may be generated by human operators or programmatically by artificial intelligence-based vector generation techniques.

At block 310 one or more attributes of lidar data encompassed by one or more buckets 404 are calculated. Thus, one or more attributes of lidar data are calculated for an individual bucket 404. The attributes may be any statistical analysis or information regarding the lidar points within the particular bucket 404. Embodiments of the present disclosure are not limited by the type of attributes that may be calculated per bucket 404. As a non-limiting example, the average elevation (i.e., z-axis value) for the lidar points within the bucket 404 may be determined. Thus, an attribute for an individual bucket 404 may be elevation. Other attributes include, but are not limited to, lidar point count, mean/median/max/min Z values and a derived value for point density in the form of X points per square meter. Other examples include gathering intensity (brightness) values for each lidar point and developing aggregate statistics on that attribute. Many other esoteric spatial metrics could be generated and utilized.

Any number of attributes may be determined for the plurality of buckets. The use of attributes for the plurality of buckets reduces the computational resources and time needed to perform subsequent analyses at block 312. Rather than performing an analysis on the entirety of the lidar data of the high definition map at run time, the attribute(s) of the plurality of buckets is used. Thus, the subsequent analyses applying the attributes of the buckets 404 use significantly less data than traditional methods.

The process continues at block 312 where one or more analyses are performed using the attributes from the plurality of buckets 404. Embodiments are not limited on the types of analyses that are performed. In one non-limiting example, the attributes of the plurality of buckets 404 are compared with features within a vector layer of the high definition map 104 that spatially coincide with the plurality of buckets 404. In other words, a vector feature within the vector layer of the high definition map 104 that is within the boundary of a particular bucket 404 may be compared with the attribute for that particular bucket 404.

For example, a road 122 of the high definition map may have a planar surface at a particular elevation as established by the lidar data. A lane line 112 within a vector layer of the high definition map 104 may be positioned “on top” of the surface of the road 122. However, one or more portions of the lane line 112 may be erroneously offset from the surface of the road 122 according to the lidar data within a lidar layer of the high definition map 104. The lane line 112 has a vector attribute in the form of an elevation value that establishes its position on the z-axis of the high definition map 104. The elevation value may be the average elevation of the lane line 112 over a particular distance, for example.

The lane line 112 passes through one or more buckets of the plurality of buckets. In the analysis at block 312, the attribute(s) of an individual bucket is compared with the vector attribute(s) of one or more vector features that reside in the individual bucket (i.e., vector features that spatially coincide with the individual bucket 404). At block 312 is it determined if there are discrepancies between the attribute(s) of the individual bucket 404 and the vector attribute(s) of the vector feature(s). For example, the vector feature for the lane line 112 may have a vector attribute of an elevation value that is greater than the attribute of an elevation value of a spatially coinciding bucket 404. In such a case, the lane line 112 will erroneously “hover” above the surface of the road 122.

It should be understood that any analysis may be performed at block 312. Further examples include utilizing brightness values for individual lidar points within the bucket and positionally comparing those values against geometric entities (such as lane boundary lines, stop/yield lines, crosswalks to name a few) derived from the lidar dataset to evaluate lateral positioning to compliment the elevation displacement analysis.

At block 314 action is taken based on the analysis performed at block 314. In some embodiments, a bucket 404 where there is a discrepancy between an attribute of the bucket 404 and a vector attribute of a vector feature is highlighted on an electronic display. The highlighting may be any visible feature indicating a discrepancy such as a particular color, a brightness, a shading, a fill pattern and/or the like. In the previous example where a lane line 112 resides above the surface of the road 122, buckets 404 where there is an elevation discrepancy may be highlighted. FIG. 4 shows a first highlighted bucket 406 and a second highlighted bucket 408 where there are one or more discrepancies between the attribute(s) of the buckets and the vector attribute(s) of vector feature(s) residing in those buckets.

In another example, the vector features are automatically adjusted based on the comparison between the attribute(s) of an individual bucket 404. In the above example, the vector attribute corresponding to the elevation of lane line can automatically updated such that the lane line 112 is on the surface of the road 122 and not hovering above. The vector features may be adjusted when the difference between the vector attribute and the attribute of the bucket exceed a threshold, for example. In another example, an action may be removal of a vector feature from the vector layer.

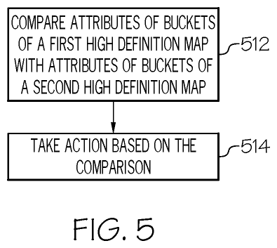

Referring now to FIG. 5, a flow chart of another method of processing a digital high definition map is illustrated. In this example there are at least two high definition maps that are compared with one another. As an example, a first high definition map and a second high definition map may have been created by two temporally separated lidar scans. Thus, different lidar data is used between the two high definition maps. It may be desired to compare one or more aspects of the two high definition maps with one another. Rather than compare the voluminous lidar data sets of the two high definition maps, one or more attributes of a plurality of blocks of the first high definition map are compared with one or more attributes of a plurality of buckets of the second high definition map at block 502. Thus, one or more attributes of spatially coinciding buckets between the first high definition map and the second high definition map are compared with one another.

At block 504 action is taken based on the comparison of the attributes between the two high definition maps. As described above with respect to block 314, the action may be highlighting buckets where there are discrepancies, or otherwise indicating the buckets with discrepancies to the user. As another example, an action may be removing some lidar data from one of the high definition maps. For example, a car may be parked on the side of the road 122 in a second high definition map. The car is represented by lidar data points. It may be desirable to remove lidar data points representing temporality located objects such as vehicles from the high definition map because they are not permanent objects. Accordingly, lidar data points representing a car that appears in a second, subsequent high definition map but does not appear in a first, previous high definition map is digitally removed from the second high definition map.

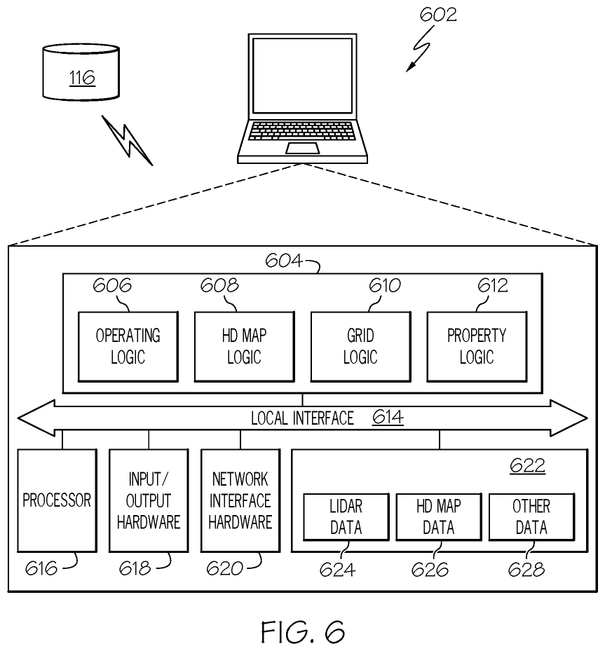

Embodiments of the present disclosure may be implemented by a computing device, and may be embodied as computer-readable instructions stored on a non-transitory memory device. Referring now to FIG. 6, an example system for processing a digital high definition map as a computing device 602 is schematically illustrated. The example computing device 602 provides a system for processing a digital high definition map, and/or a non-transitory computer usable medium having computer readable program code for processing a digital high definition map embodied as hardware, software, and/or firmware, according to embodiments shown and described herein. While in some embodiments, the computing device 602 may be configured as a general purpose computer with the requisite hardware, software, and/or firmware, in some embodiments, the computing device 602 may be configured as a special purpose computer designed specifically for performing the functionality described herein. It should be understood that the software, hardware, and/or firmware components depicted in FIG. 6 may also be provided in other computing devices external to the computing device 602 (e.g., data storage devices, remote server computing devices, and the like).

As also illustrated in FIG. 6, the computing device 602 (or other additional computing devices) may include a processor 616, input/output hardware 618, network interface hardware 620, a data storage component 622 (which may include lidar data 624 (e.g., data generated by a lidar scanning device 116), high definition map data 626 (e.g., data including lidar data, vector data within a vector layer, and other map data), and any other data 628 for performing the functionalities described herein), and a non-transitory memory component 604. The memory component 604 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 604 may be configured to store operating logic 606, high definition map data 608 for creating a high definition map from at least lidar data and vector data, bucket logic 610 for overlaying a grid and generating a plurality of buckets, and attribute logic 612 for calculating one or more attributes for each bucket, as described herein (each of which may be embodied as computer readable program code, firmware, or hardware, as an example). It should be understood that the data storage component 622 may reside local to and/or remote from the computing device 602, and may be configured to store one or more pieces of data for access by the computing device 602 and/or other components.

A local interface 614 is also included in FIG. 6 and may be implemented as a bus or other interface to facilitate communication among the components of the computing device 602.

The processor 616 may include any processing component configured to receive and execute computer readable code instructions (such as from the data storage component 622 and/or memory component 604). The input/output hardware 618 may include virtual reality headset, graphics display device, keyboard, mouse, printer, camera, microphone, speaker, touch-screen, and/or other device for receiving, sending, and/or presenting data. The network interface hardware 620 may include any wired or wireless networking hardware, such as a modem, LAN port, wireless fidelity (Wi-Fi) card, WiMax card, mobile communications hardware, and/or other hardware for communicating with other networks and/or devices, such as the lidar scanning device 116.

Included in the memory component 604 may be the operating logic 606, data high definition map logic 608, bucket logic 610, and attribute logic 612. The operating logic 606 may include an operating system and/or other software for managing components of the computing device 602. Similarly, the high definition map logic may reside in the memory component 604 and may be configured to generate a high definition map from lidar and vector data. The bucket logic 610 also may reside in the memory component 604 and may be configured to generate the buckets surrounding lidar points. The attribute logic 612 includes logic to determine the one or more attributes of the plurality of buckets.

The components illustrated in FIG. 6 are merely exemplary and are not intended to limit the scope of this disclosure. More specifically, while the components in FIG. 6 are illustrated as residing within the computing device 602, this is a non-limiting example. In some embodiments, one or more of the components may reside external to the computing device 602.

It should now be understood that embodiments of the present disclosure are directed to systems and methods for detecting discrepancies within high definition maps in a computational efficient manner, thereby saving processing time and power. Embodiments reduce the amount of data used when detecting discrepancies by forming buckets of lidar points and determining one or more attributes of the lidar points for each of the buckets. These attributes are then utilized to determine discrepancies, such as discrepancies between lidar data and vector data of a high definition map, or discrepancies between the lidar data of two high definition maps of the same geographical area.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for processing a high definition map, the method comprising:
scanning an environment with a lidar scanner to generate lidar data;
generating the high definition map from the lidar data, wherein the high definition map further comprises a plurality of features defined by vector data derived from the lidar data;
applying a plurality of buckets to the high definition map, wherein each bucket of the plurality of buckets comprises a plurality of lidar points of the lidar data;
for each bucket of the plurality of buckets, determining an attribute from the plurality of lidar points; and
adjusting one or more features of the plurality of features based at least in part on attributes of the plurality of buckets.

2. The method of claim 1, further comprising:
for one or more buckets of the plurality of buckets, comparing the attribute with a vector attribute of an individual feature of the plurality of features that spatially coincides with the plurality of buckets; and
the adjusting of the one or more features is performed when a difference between the attribute of an individual bucket and the vector attribute of the individual feature is greater than a threshold.

3. The method of claim 1, wherein the attribute is elevation.

4. The method of claim 1, wherein the adjusting of the one or more features is changing an elevation of the one or more features.

5. The method of claim 1, wherein the adjusting of the one or more features is the removal of at least one of the one or more features from the high definition map.

6. The method of claim 1, further comprising displaying the high definition map and the plurality of buckets on an electronic display.

7. The method of claim 6, further comprising:
for one or more buckets of the plurality of buckets, comparing the attribute with a vector attribute of an individual feature of the plurality of features that spatially coincides with the one or more buckets; and
highlighting each bucket on the electronic display having a difference between the attribute of an individual bucket and the vector attribute of the individual feature that is greater than a threshold.

8. The method of claim 1, further comprising generating the plurality of buckets by applying a uniform grid comprising an array of control points over the high definition map, and from each control point, generating a polygon from lidar points surrounding the control point, wherein the polygon defines the bucket.

9. A system for processing a high definition map, the system comprising:
one or more processors; and
a non-transitory computer-readable medium storing instructions that, when executed by the one or more processors, cause the one or more processors to:
receive lidar data of an environment;
generate the high definition map from the lidar data, wherein the high definition map further comprises a plurality of features defined by vector data derived from the lidar data;
apply a plurality of buckets to the high definition map, wherein each bucket of the plurality of buckets comprises a plurality of lidar points of the lidar data;
for each bucket of the plurality of buckets, determine an attribute from the plurality of lidar points; and
adjusting one or more features of the plurality of features based at least in part on attributes of the plurality of buckets.

10. The system of claim 9, further comprising:
for one or more buckets of the plurality of buckets, comparing the attribute with a vector attribute of an individual feature of the plurality of features that spatially coincides with the one or more buckets; and
the adjusting of the one or more features is performed when a difference between the attribute of an individual bucket and the vector attribute of the individual feature is greater than a threshold.

11. The system of claim 9, wherein the attribute is elevation.

12. The system of claim 9, wherein the adjusting of the one or more features is changing an elevation of the one or more features.

13. The system of claim 9, wherein the adjusting of the one or more features is the removal of at least one of the one or more features from the high definition map.

14. The system of claim 9, wherein the instructions further cause the one or more processors to display the high definition map and the plurality of buckets on an electronic display.

15. The system of claim 14, wherein the instructions further cause the one or more processors to:
for one or more buckets of the plurality of buckets, compare the attribute with a vector attribute of an individual feature of the plurality of features that spatially coincides with the one or more buckets; and
highlight each bucket of the uniform grid on the electronic display having a difference between the attribute of an individual bucket and the vector attribute of the individual feature that is greater than a threshold.

16. A system for processing a high definition map, the system comprising:
one or more processors; and
a non-transitory computer-readable medium storing instructions that, when executed by the one or more processors, cause the one or more processors to:
receive first lidar data of an environment;
receive second lidar data from the environment;
generate a first high definition map from the first lidar data and a second high definition map from the second lidar data, wherein each of the first high definition map and the second high definition map comprises a plurality of features defined by vector data derived from the first lidar data and the second lidar data, respectively;
apply a first plurality of buckets to the first high definition map and a second plurality of buckets to the second high definition map, wherein each bucket of the first plurality of buckets and the second plurality of buckets comprises a plurality of lidar points of one of the first lidar data and the second lidar data;
for each bucket of the first plurality of buckets and the second plurality of buckets, determine an attribute from the plurality of lidar points of the first lidar data and the second lidar data, respectively;
compare the attribute of each bucket of the first plurality of buckets to the attribute of each spatially corresponding bucket of the second plurality of buckets; and
display the second high definition map and the second plurality of buckets on an electronic display, wherein each bucket of the second plurality of buckets visually indicates a difference between the attribute of an individual bucket and the spatially corresponding bucket of the first plurality of buckets.

17. The system of claim 16, wherein the attribute is elevation.

18. The system of claim 16, wherein the instructions further cause the one or more processors to determine an object present in the second high definition map that is not present in the second high definition map.

19. The system of claim 16, wherein the instructions further cause the one or more processors to remove an object from the second high definition map.

20. The system of claim 16, further comprising generating the first plurality of buckets and the second plurality of buckets by applying a uniform grid comprising an array of control points over the first high definition map and the second high definition map, respectively, and from each control point, generating a polygon from lidar points surrounding the control point, wherein the polygon defines the bucket.
